(19) United States
(12) Patent Application Publication
(10) Pub. No.: US 2026/0139096 A1
(43) Pub. Date: May 21, 2026

(54) THERMOPLASTIC RESIN AND OPTICAL MEMBER

(71) Applicant: TEIJIN LIMITED, Osaka (JP)

(72) Inventors: Kyosuke YAMADA, Osaka (JP); Kazunori NUNOME, Osaka (JP)

(73) Assignee: TEIJIN LIMITED, Osaka (JP)

(21) Appl. No.: 18/704,292

(22) PCT Filed: Oct. 18, 2022
(86) PCT No.: PCT/JP2022/038779

§ 371 Date: Apr. 24, 2024

(30) Foreign Application Priority Data
Oct. 26, 2021 (JP) 2021-174561

(51) Int. Cl. C08G 64/06; C08G 63/187; C08G 63/197; C08G 63/672; C08G 64/30; G02B 1/04

(52) U.S. Cl. CPC C08G 64/06; C08G 63/187; C08G 63/197; C08G 63/672; C08G 64/305; G02B 1/041

(57) ABSTRACT

The present invention provides a thermoplastic resin that can provide balance among a high refractive index, high heat resistance, and low birefringence, and also provides an optical member that contains this thermoplastic resin. The thermoplastic resin according to the present invention contains a repeat unit represented by formula (1).

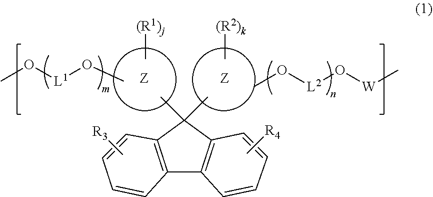

where the rings Z (which may be the same or may differ) each represent a polycyclic aromatic hydrocarbon in which at least three benzene rings are bonded; R¹, R², R³, and R⁴ each independently are a hydrogen atom or a halogen atom or represent a C1-C20 substituent which may contain an aromatic group; L¹ and L² each independently represent a divalent linking group; j and k each independently represent an integer equal to or greater than 1; m and n each independently represent 0 or 1; and W is at least one selected from the group represented by Formula (2) or (3) below:

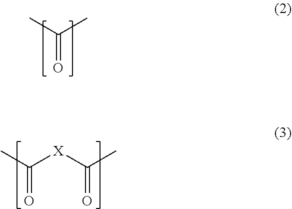

where X represents a divalent linking group.

### FIELD

The present invention relates to a thermoplastic resin that can provide a balance of high refractive index, high heat resistance, and low birefringence.

### BACKGROUND

Imaging modules are used in cameras, video cameras, mobile phones with cameras, videophones, and doorbells with cameras. In recent years, there has been a particular demand for miniaturization of optical systems used in these imaging modules. As an optical system miniaturizes, chromatic aberration in the optical system becomes a significant issue. It is known that by combining an optical lens material having a high refractive index and a small Abbe number to achieve high dispersion and an optical lens material having a low refractive index and a large Abbe number to achieve low dispersion in an optical lens, chromatic aberration can be corrected.

Glass, which has been conventionally used as a material for optical systems, can achieve various required optical characteristics and has excellent environmental resistance, but has the issue of poor workability. On the other hand, resins, which are low-cost and have excellent workability compared to glass materials, have been used for optical components. Particularly, resins having a fluorene skeleton or a binaphthalene skeleton are used for reasons such as high refractive index. For example, PTL 1 and PTL 2 describe a high-refractive-index resin having a refractive index of 1.64 that uses 9,9-bis(4-(2-hydroxyethoxy)phenyl) fluorene. However, depending on the optical lens used, the refractive index is insufficient, and a higher refractive index is required. In addition. PTL 3 describes a thermoplastic resin comprising 9,9-bis(4-(2-hydroxyethoxy)-3-phenylphenyl) fluorene.

To achieve a high refractive index, PTL 4 and 5 describe a thermoplastic resin in which an aromatic ring is introduced into a fluorene skeleton using a coupling technique. Although high refractive index and high heat resistance were achieved, there was an issue in that birefringence also increased as the refractive index increased due to expansion of conjugation centered on the fluorene moiety. In addition, the high cost due to raw materials used in coupling reactions and an increase in the number of process steps led to a prolongation of the manufacturing process.

An object of the present invention is to provide a thermoplastic resin having an excellent balance of high refractive index, high heat resistance, and low birefringence and an optical member comprising the same.

### CITATION LIST

### Patent Literature

[PTL 1] WO 2007/142149
[PTL 2] Japanese Unexamined Patent Publication (Kokai) No. 7-198901
[PTL 3] Japanese Unexamined Patent Publication (Kokai) No. 2015-86265
[PTL 4] WO 2019/044214
[PTL 5] Japanese Unexamined Patent Publication (Kokai) No. 2020-12094

### SUMMARY

### Technical Problem

The object to be achieved in the present invention is to provide a thermoplastic resin that can provide a balance of high refractive index, high heat resistance, and low birefringence and an optical member comprising the same.

### Solution to Problem

As a result of intensive studies to achieve this purpose, the present inventors have discovered that a thermoplastic resin, comprising a specific compound having introduced therein a polycyclic aromatic hydrocarbon of 3 or more bonded benzene rings, can achieve the above object, and have completed the present invention. Specifically, the present invention is as follows.

### <<Aspect 1>>

A thermoplastic resin comprising a repeating unit represented by Formula (1) below:

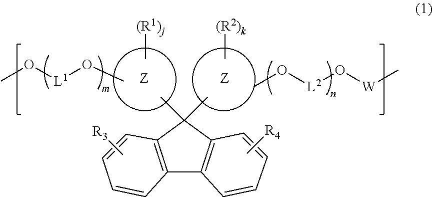

where rings Z (identical or different) each represent a polycyclic aromatic hydrocarbon of 3 or more bonded benzene rings; R¹, R², R³, and R⁴ are each independently a hydrogen atom or a halogen atom or represent a substituent having 1 to 20 carbon atoms that may comprise an aromatic group; L¹ and L² each independently represent a divalent linking group; j and k each independently represent an integer of 1 or greater; m and n each independently represent 0 or 1; and W is at least one selected from the group represented by Formula (2) or (3) below:

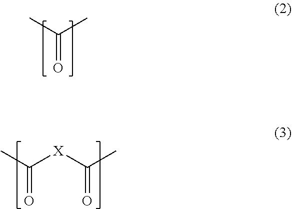

where X represents a divalent linking group.

### <<Aspect 2>>

The thermoplastic resin according to Aspect 1, wherein the repeating unit represented by the Formula (1) is at least one selected from the group represented by Formulas (1a) to (1d) below:

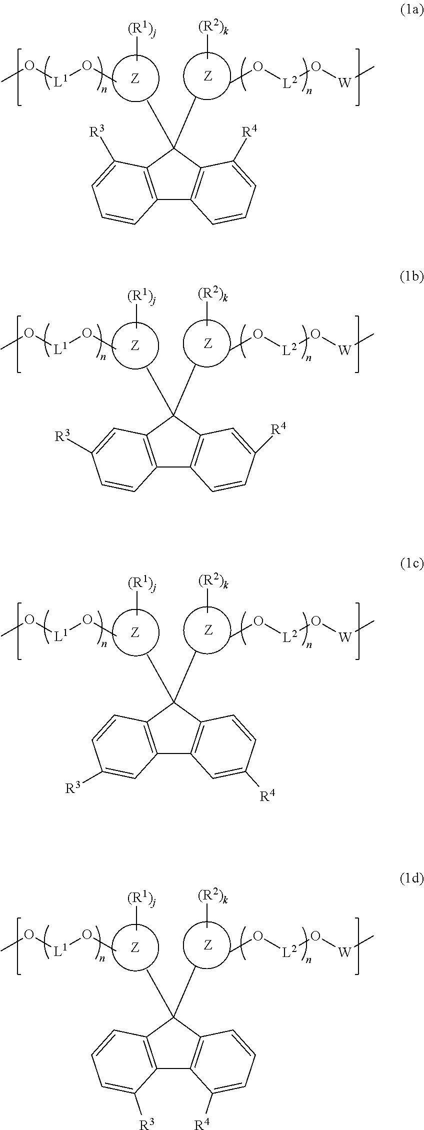

where rings Z (identical or different) are each a polycyclic aromatic hydrocarbon of 3 or more bonded benzene rings; R¹, R², R³, and R⁴ are each independently a hydrogen atom or a halogen atom or represent a substituent having 1 to 20 carbon atoms that may comprise an aromatic group; L¹ and L² each independently represent a divalent linking group; j and k each independently represent an integer of 1 or greater; m and n each independently represent 0 or 1; and W is at least one selected from the group represented by the Formula (2) or (3).

### <<Aspect 3>>

The thermoplastic resin according to Aspect 2, wherein the Formula (1) is the Formula (1b).

### <<Aspect 4>>

The thermoplastic resin according any one of Aspects 1 to 3, wherein ring Z in the Formula (1) is a phenacene-type polycyclic aromatic hydrocarbon.

### <<Aspect 5>>

The thermoplastic resin according to any one of Aspects 1 to 4, wherein ring Z in the Formula (1) is phenanthrene.

### <<Aspect 6>>

The thermoplastic resin according to any one of Aspects 1 to 5, wherein the repeating unit represented by the Formula (1) is represented by Formula (4) below:

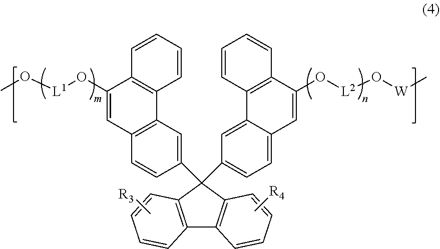

where R³ and R⁴ are each independently a hydrogen atom or a halogen atom or represent a substituent having 1 to 20 carbon atoms that may comprise an aromatic group; L¹ and L² each independently represent a divalent linking group; m and n each independently represent 0 or 1; and W is at least one selected from the group represented by the Formula (2) or (3).

### <<Aspect 7>>

The thermoplastic resin according to any one of Aspects 1 to 6, where in the Formula (1), R³ and R⁴ each represent a hydrogen atom, a methyl group, a phenyl group, a naphthyl group, or a phenanthryl group.

### <<Aspect 8>>>

The thermoplastic resin according to any one of Aspects 1 to 7, wherein R³ and R⁴ in the Formula (1) are each a hydrogen atom.

### <<Aspect 9>>

The thermoplastic resin according to any one of Aspects 1 to 8, wherein X in the Formula (3) comprises, as a repeating unit, at least one selected from the group consisting of a phenylene group, a naphthalenediyl group, a group represented by Formula (5) below, and a group represented by Formula (6) below:

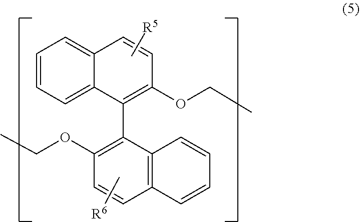

where R⁵ and R⁶ are each independently a hydrogen atom or a halogen atom, or a hydrocarbon group having 1 to 20 carbon atoms that may comprise an aromatic group, and

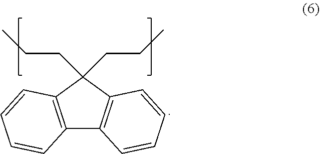

### <<Aspect 10>>

The thermoplastic resin according to any one of Aspects 1 to 9, comprising, as a repeating unit, at least one selected from the group consisting of units represented by Formulas (7) to (10) below:

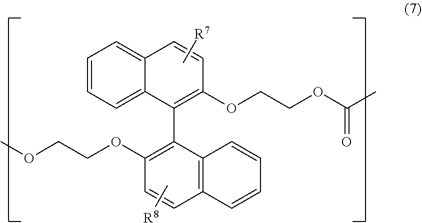

where R⁷ and R⁸ are each independently a hydrogen atom or a halogen atom, or a hydrocarbon group having 1 to 20 carbon atoms that may comprise an aromatic group,

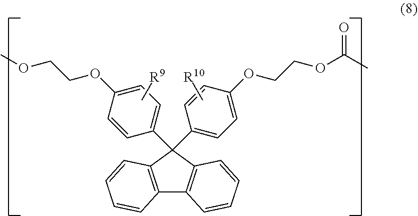

where R⁹ and R¹⁰ are each independently a hydrogen atom or a halogen atom, or a substituent having 1 to 20 carbon atoms that may comprise an aromatic group,

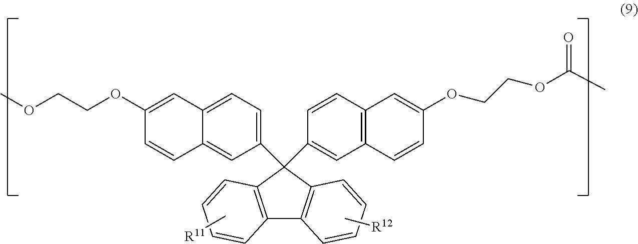

where R¹¹ and R¹² are each independently a hydrogen atom or a halogen atom, or a substituent having 1 to 20 carbon atoms that may comprise an aromatic group, and

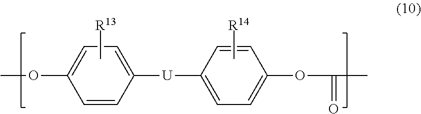

where R¹³ and R¹⁴ are each independently a hydrogen atom or a halogen atom, or a substituent having 1 to 20 carbon atoms that may comprise an aromatic group; and U is a single bond or a divalent linking group.

### <<Aspect 11>>

The thermoplastic resin according to any one of Aspects 1 to 10, which has a specific viscosity of 0.12 to 0.40.

### <<Aspect 12>>

The thermoplastic resin according to any one of Aspects 1 to 11, which has a refractive index of 1.65 to 1.80.

### <<Aspect 13>

The thermoplastic resin according to any one of Aspects 1 to 12, which has a glass transition temperature of 130 to 190° C.

### <<Aspect 14>>

The thermoplastic resin according to any one of Aspects 1 to 13, which has an absolute value of orientation birefringence of 6.0×10⁻³ or less.

### <<Aspect 15>>

An optical member comprising the thermoplastic resin according to any one of Aspects 1 to 14.

### <<Aspect 16>>

The optical member according to Aspect 15, which is an optical lens.

### Advantageous Effects of Invention

The thermoplastic resin of the present invention has an excellent balance of high refractive index, high heat resistance, and low birefringence, and thus can be used for optical members such as optical lenses, prisms, optical disks, transparent conductive boards, optical cards, sheets, films, optical fibers, optical membranes, optical filters, and hard coatings, and is very useful for optical lenses for use particularly in mobile phones, smartphones, tablet terminals, personal computers, digital cameras, video cameras, in-vehicle cameras, and surveillance cameras. Therefore, the industrial effect brought about thereby is exceptional.

### BRIEF DESCRIPTION OF DRAWINGS

FIG. 1 is a H NMR of 9,9-bis[9-(2-hydroxyethoxy)-3-phenanthryl]fluorene obtained in Reference Example 1.

FIG. 2 is a H NMR of polycarbonate resin obtained in Example 1.

### DESCRIPTION OF EMBODIMENTS

The present invention will now be described in detail.

### <Thermoplastic Resin>

As the thermoplastic resin of the present invention, a thermoplastic resin comprising a repeating unit represented by Formula (1) below is used:

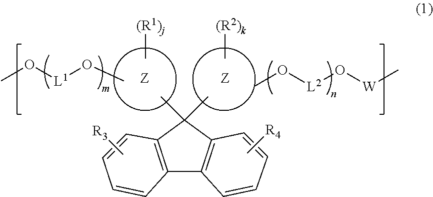

where rings Z (identical or different) are each a polycyclic aromatic hydrocarbon of 3 or more bonded benzene rings; R¹, R², R³, and R⁴ are each independently a hydrogen atom or a halogen atom or represent a substituent having 1 to 20 carbon atoms that may comprise an aromatic group: L¹ and L² each independently represent a divalent linking group: j and k each independently represent an integer of 1 or greater; m and n each independently represent 0 or 1; and W is at least one selected from the group represented by Formula (2) or (3) below:

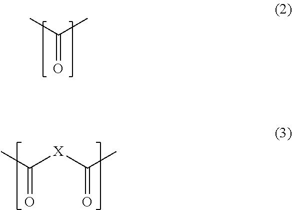

where X is a divalent linking group.

In the Formula (1), rings Z (identical or different) are each a polycyclic aromatic hydrocarbon group of 3 or more fused benzene rings, preferably a polycyclic aromatic hydrocarbon of 3 or 4 fused benzene rings, and more preferably a polycyclic aromatic hydrocarbon of 3 fused benzene rings.

In the Formula (1), the polycyclic aromatic hydrocarbon of ring Z is preferably a structure of benzene rings fused in an acene type or a phenacene type, and more preferably a structure of benzene rings fused in a phenacene type.

In the Formula (1), ring Z is preferably anthracene, phenanthrene, pyrene, or chrysene, more preferably anthracene or phenanthrene, and from the viewpoint of stability due to differences in frontier orbitals when the number of fused rings increases, even more preferably phenanthrene.

In the Formula (1), R¹ and R² are each independently a hydrogen atom or a halogen atom or represent a substituent having 1 to 20 carbon atoms that may comprise an aromatic group, and are each preferably a hydrogen atom, a methyl group, a phenyl group, or a naphthyl group, more preferably a hydrogen atom, a methyl group, or a phenyl group, even more preferably a hydrogen atom or a methyl group, and particularly preferably a hydrogen atom.

In the Formula (1), R³ and R⁴ are each independently a hydrogen atom or a halogen atom or represent a substituent having 1 to 20 carbon atoms that may comprise an aromatic group, and are each preferably a hydrogen atom, a methyl group, a phenyl group, a naphthyl group, or a phenanthryl group, more preferably a hydrogen atom, a phenyl group, a naphthyl group, or a phenanthryl group, even more preferably a hydrogen atom, a phenyl group, or a naphthyl group, and particularly preferably a hydrogen atom.

The respective bonding positions of R³ and R⁴ are preferably positions 1 and 8 (Formula (1a) below), positions 2 and 7 (Formula (1b) below), positions 3 and 6 (Formula (1c) below), or positions 4 and 5 (Formula (1d) below) of the fluorene skeleton, more preferably the positions 2 and 7, the positions 3 and 6, or the positions 4 and 5, and even more preferably the positions 2 and 7:

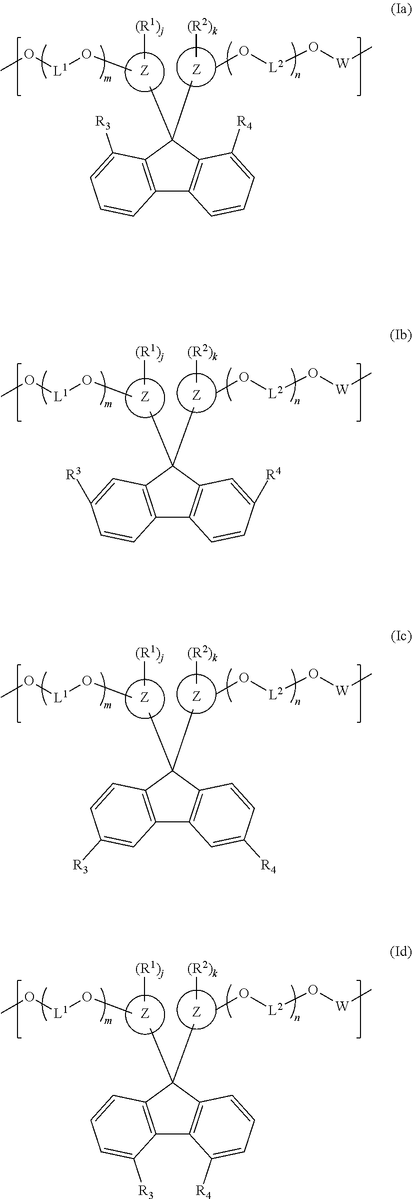

where rings Z, R¹, R², R³, R⁴, L¹, L², j, k, m, n, and W are the same as those in the Formula (1).

In the Formula (1), L¹ and L² each independently represent a divalent linking group, and are each preferably an alkylene group having 1 to 12 carbon atoms, more preferably an alkylene group having 1 to 4 carbon atoms, and even more preferably ethylene. By adjusting the lengths of the linking groups L¹ and L², the glass transition temperature (Tg) of the resin can be adjusted.

In the Formula (1), W is at least one selected from the group represented by the Formula (2) or (3). When W is the Formula (2), the Formula (1) is a carbonate unit. When W is the Formula (3), the Formula (1) is an ester unit.

The repeating unit represented by the Formula (1) can be obtained from a dihydroxy compound and a carbonate precursor such as a carbonate ester, or a dihydroxy compound and a dicarboxylic acid or an ester-forming derivative thereof.

In the Formula (1), m and n are each independently 0 or 1, and more preferably 1.

In the Formula (1), j and k are each independently an integer of 1 or greater, preferably an integer of 1 to 4, and more preferably 1.

The repeating unit represented by the Formula (1) is preferably a repeating unit represented by Formula (11) below:

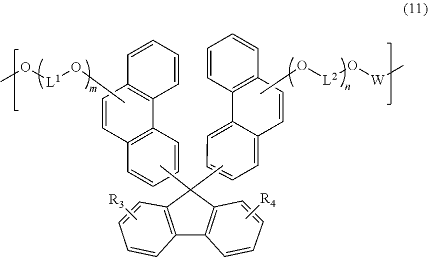

where R³ and R⁴, L¹ and L², m and n, and W are the same as those in the Formula (1).

In the Formula (11), the combination of the bonding position from the phenanthrene skeleton to the fluorene skeleton and the position of the linking group comprising an oxygen atom in the phenanthrene skeleton is preferably that of, respectively, positions 1 and 6, positions 3 and 6, positions 3 and 9 (Formula (4) below), or positions 3 and 10, more preferably positions 3 and 9 or positions 3 and 10, and even more preferably positions 3 and 9:

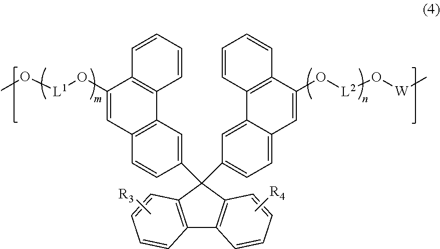

where R³ and R⁴, L¹ and L², m and n, and W are the same as those in the Formula (1).

The repeating unit represented by the Formula (1) is more preferably a repeating unit represented by Formula (12) below:

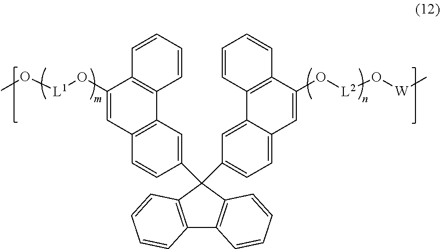

where L¹ and L², m and n, and W are the same as those in the Formula (1).

In the Formula (3), X represents a divalent linking group, and is preferably a substituent having 1 to 30 carbon atoms that may comprise an aromatic group, and more preferably a phenylene group, a naphthalenediyl group, a group represented by Formula (5) below, or a group represented by Formula (6) below:

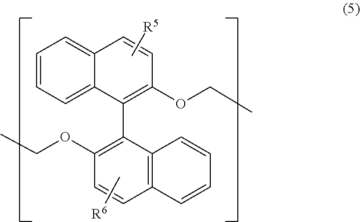

where R⁵ and R⁶ are each independently a hydrogen atom or a halogen atom, or a hydrocarbon group that may comprise an aromatic group having 1 to 20 carbon atoms, and

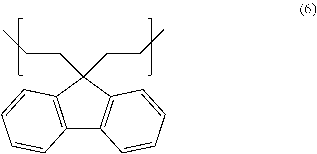

In the Formula (5), R⁵ and R⁶ are each independently a hydrogen atom or a halogen atom or represent a substituent having 1 to 20 carbon atoms that may comprise an aromatic group, and are each preferably a hydrogen atom, a methyl group, a phenyl group, or a naphthyl group, more preferably a hydrogen atom, a methyl group, or a phenyl group, even more preferably a hydrogen atom or a phenyl group, and particularly preferably a hydrogen atom.

The following is considered a reason for allowing for a high-degree balance of high refractive index, high heat resistance, and low birefringence as the effect of the present invention.

PTL 5 describes a thermoplastic resin obtained by using a compound in which an aromatic group having 6 to 10 carbon atoms is introduced into a side chain of a fluorene skeleton, such as 9,9-bis(6-(2-hydroxyethoxy)-2-naphthyl)-2,7-diphenylfluorene (hereinafter, also referred to as “BNDP2”) having the following formula.

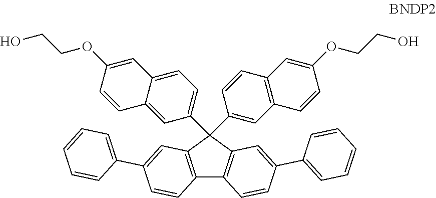 [SMILES: OCCOc1ccc2cc(C3(c4ccc5cc(OCCO)ccc5c4)c4cc(-c5ccccc5)ccc4-c4ccc(-c5ccccc5)cc43)ccc2c1]

PLT 4 describes that refractive index and birefringence are both improved by the expansion of conjugation of the introduced aromatic group and the fluorene moiety.

The present inventors have discovered that in a polymer having a main chain comprising a polycyclic aromatic hydrocarbon group of 3 or more fused benzene rings, an increase in birefringence can be suppressed and the refractive index can be increased. It is considered that the trade-off between the effect of refractive index improvement and the increase in birefringence, which was an issue in the prior art, can be solved.

From the relative equation between molecular structure and refractive index known as the Lorentz-Lorenz equation, it is known that the refractive index of a substance is increased by increasing electron density of the molecule and decreasing molecular volume. Based on this theory, a high refractive index is achieved in a conventional resin having a fluorene skeleton by introducing a large number of aromatic groups into the molecule. When an aromatic group is introduced into a fluorene side chain, electron density is increased due to the expansion of the conjugated structure. As a result, although the refractive index is increased, the difference in refractive index between the main chain (orientation direction) and the side chain (orthogonal direction) widens and birefringence of the resin worsens. Specifically, in achieving a high refractive index, the suppression of birefringence is required.

Since the polymers developed in the present invention, which have a main chain comprising a polycyclic aromatic hydrocarbon group of 3 or more fused benzene rings, particularly the polymer having a phenacene group introduced therein, have a bent structure, the orientation in the main chain direction is small, and an increase in refractive index is achieved while the birefringence of the polymer is suppressed. Among the hydrocarbon groups, a phenanthryl group had an excellent balance of refractive index and birefringence.

The thermoplastic resin of the present invention has a large number of aromatic groups introduced therein, and thus it is possible to increase heat resistance and achieve a balance with moldability.

The thermoplastic resin represented by Formula (1) of the present invention may comprise the repeating unit represented by the Formula (1) in an amount of 5 mol % or greater, 10 mol % or greater, 15 mol % or greater, 20 mol % or greater, 25 mol % or greater, or 30 mol % or greater and in an amount of 100 mol % or less, 90 mol % or less, 80 mol % or less, 70 mol % or less, 60 mol % or less, or 50 mol % or less. The resin of the present invention can comprise the repeating unit represented by the Formula (1) in an amount of preferably 10 mol % or greater and 100 mol % or less, more preferably 20 mol % or greater and 100 mol % or less, even more preferably 20 mol % or greater and 80 mol % or less, and particularly preferably 20 mol % or greater and 70 mol % or less. It is preferable that the repeating unit represented by the Formula (1) be within the above range for an excellent balance of refractive index, heat resistance, and moldability.

The thermoplastic resin of the present invention can comprise, as a repeating unit, at least one selected from the group consisting of units represented by Formulas (7) to (10) below:

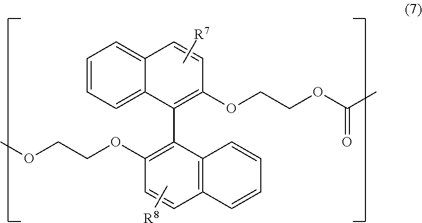

where R⁷ and R⁸ are the same as R⁵ and R⁶ in the Formula (5),

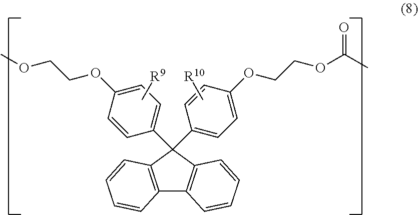

where R⁹ and R¹⁰ are the same as R⁵ and R⁶ in the Formula (5),

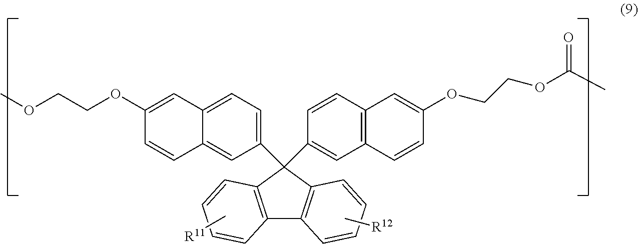

where R 11 and R¹² are the same as R⁵ and R⁶ in the Formula (5), and

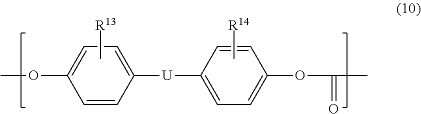

where R¹³ and R¹⁴ are the same as R⁵ and R⁶ in the Formula (5) and U represents a single bond or a divalent linking group.

The mol ratio of repeating units represented by the Formula (1) to repeating units of the group consisting of units represented by the Formulas (7) to (10) is preferably 95:5 to 5:95, more preferably 80:20 to 20:80, and even more preferably 70:30 to 30:70.

It is preferable that the mol ratio of repeating units represented by the Formula (1) to repeating units of at least one selected from the group consisting of units represented by the Formulas (7) to (10) be within the above range for a high refractive index and an excellent balance of moldability therewith.

### <Physical Properties of Thermoplastic Resin>

The specific viscosity of the thermoplastic resin of the present invention is preferably 0.12 to 0.40, more preferably 0.14 to 0.35, and even more preferably 0.16 to 0.30. It is preferably that the specific viscosity be within the above range for an excellent balance of moldability and mechanical strength.

For the measurement method of the specific viscosity, specific viscosity (ηSP) at 20° C. of a solution having 0.7 of the thermoplastic resin dissolved in 100 ml of methylene chloride is measured using an Ostwald viscometer and calculated from the following formula.

Specific viscosity(ηSP)=(t−t₀)/t₀

[to is number of seconds to drop methylene chloride, and t is number of seconds to drop the sample solution.]

The refractive index of the thermoplastic resin of the present invention, when measured at temperature: 20° C., and wavelength: 587.56 nm, is 1.65 or greater and may be 1.66 or greater, 1.67 or greater, 1.68 or greater, 1.69 or greater, or 1.70 or greater, and is 1.80 or less and may be 1.79 or less, 1.78 or less, 1.77 or less, 1.76 or less, or 1.75 or less. The refractive index is preferably 1.65 to 1.80, more preferably 1.66 to 1.80, even more preferably 1.67 to 1.80, particularly preferably 1.68 to 1.80, and most preferably 1.69 to 1.80. When the refractive index is at the lower limit or higher, spherical aberration in an optical lens can be decreased, and further the focal length of the optical lens can be shortened.

The thermoplastic resin of the present invention has a high refractive, and further preferably has a low Abbe number.

The Abbe number of the thermoplastic resin of the present invention may be 5 or greater, 7 or greater, 9 or greater, 10 or greater, 12 or greater, or 14 or greater, and may be 24 or less, 23 or less. 22 or less, 21 or less, 20 or less, 19 or less, or 18 or less. The Abbe number (vd) is preferably 5 to 22, more preferably 7 to 22, and even more preferably 10 to 21.

The Abbe number is calculated at temperature: 20° C., and refractive indices at wavelengths: 486.13 nm, 587.56 nm, and 656.27 nm, using the following formula:

$$vd = ( nd - 1 ) / ( nF - nC )$$

$$nd : refractive index at wavelength of 587.56 nm ,$$

$$nF : refractive index at wavelength of 486.13 nm , and$$

$$nC : refractive index at wavelength of 656.27 nm .$$

For the thermoplastic resin of the present invention, the glass transition temperature (Tg) may be 130° C. or higher, 135° C. or higher, 140° C. or higher, 145° C. or higher, or 150° C. or higher, and may be 190° C.′ or lower, 185° C. or lower, 180° C. or lower, 175° C. or lower, or 170° C. or lower. The glass transition temperature is preferably 130 to 190° C., more preferably 140 to 185° C., and even more preferably 140 to 180° C. It is preferable that the glass transition temperature be within the above range for an excellent balance of heat resistance and moldability.

For the thermoplastic resin of the present invention, the absolute value (|Δn|) of orientation birefringence is 6.0×10⁻³ or less, and is preferably 5.0×10⁻³ or less, more preferably 4.5×10⁻³ or less, even more preferably 4.0×10⁻³ or less, particularly preferably 3.5×10⁻³ or less, and most preferably 3.0×10⁻³ or less. It is preferable that |Δn| be within the above range for a small optical distortion in the optical lens.

The absolute value (|Δn|) of orientation birefringence is determined by the following formula, by stretching a film having a thickness of 100 μm obtained from the thermoplastic resin of the present invention two-fold at a temperature of Tg+10° C., and measuring the retardation at a wavelength of 589 nm.

$$\vert Δ n \vert = \vert Re / d \vert$$

$$Δ n : orientation birefringence$$

$$Re : retardation ( nm )$$

$$d : thickness ( nm )$$

For the thermoplastic resin of the present invention, the water absorption rate after immersion in water at 23° C. for 24 h is preferably 0.25% by mass or less, and more preferably 0.20% by mass or less. It is preferable that the water absorption rate be within the above range for a small change in optical characteristics due to water absorption.

### <Raw Material of Thermoplastic Resin>

### (Diol Component in Formula (1))

The diol component as a raw material in Formula (1) is mainly a diol component represented by Formula (a), and may be used individually, or may be used in a combination of two or more.

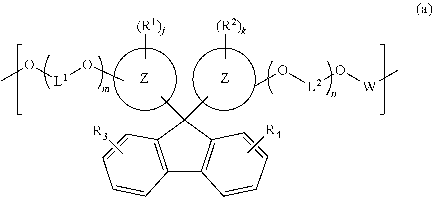

In the Formula (a), rings Z, R¹ and R², R³, R⁴, L¹ and L², j and k, and m and n are the same as those in each formula of the Formula (1).

Hereinafter, typical specific examples of the dihydroxy compound represented by the Formula (a) are shown. However, the raw materials used in the Formula (1) of the present invention are not limited thereto.

When rings Z are each phenanthrene and R³ and R⁴ are each a hydrogen atom, examples thereof include 9,9-bis[9-(2-hydroxyethoxy)-3-phenanthryl]fluorene represented by Formula (a-1) below and 9,9-bis(3-hydroxyphenanthryl) fluorene represented by (a-2).

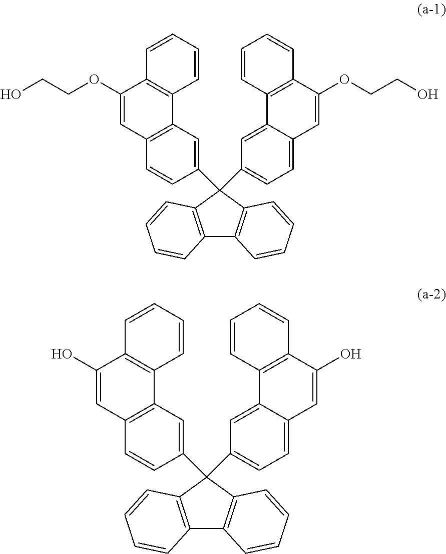 [SMILES: OCCOc1cc2ccc(C3(c4ccc5cc(OCCO)c6ccccc6c5c4)c4ccccc4-c4ccccc43)cc2c2ccccc12 ; Oc1cc2ccc(C3(c4ccc5cc(O)c6ccccc6c5c4)c4ccccc4-c4ccccc43)cc2c2ccccc12]

When rings Z are each phenanthrene and R³ and R⁴ are each a phenyl group, examples thereof include 9,9-bis[9-(2-hydroxyethoxy)-3-phenanthryl]-1,8-diphenylfluorene, 9,9-bis(3-hydroxyphenanthryl)-1,8-diphenylfluorene, 9,9-bis[9-(2-hydroxyethoxy)-3-phenanthryl]-2,7-diphenylfluorene, 9,9-bis(3-hydroxyphenanthryl)-2,7-diphenylfluorene, 9,9-bis[9-(2-hydroxyethoxy)-3-phenanthryl]-3,6-diphenylfluorene, 9,9-bis(3-hydroxyphenanthryl)-3,6-diphenylfluorene, 9,9-bis[9-(2-hydroxyethoxy)-3-phenanthryl]-4,5-diphenylfluorene, and 9,9-bis(3-hydroxyphenanthryl)-4,5-diphenylfluorene, represented by Formula (a-3) below.

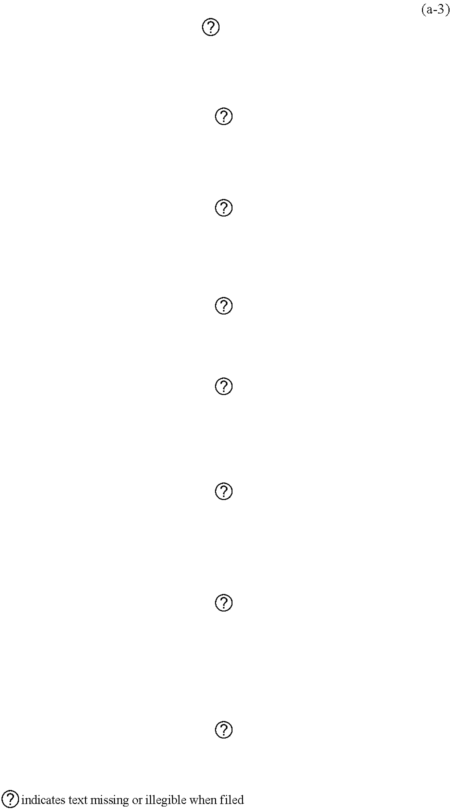

When rings Z are each phenanthrene and R³ and R⁴ are each 1-naphthalene, examples thereof include 9,9-bis[9-(2-hydroxyethoxy)-3-phenanthyl]-1,8-di(1-naphthyl) fluorene, 9,9-bis(3-hydroxy phenanthryl)-1,8-di(1-naphthyl) fluorene, 9,9-bis[9-(2-hydroxyethoxy)-3-phenanthryl]-2,7-di(1-naphthyl) fluorene, 9,9-bis(3-hydroxyphenanthryl)-2,7-di(1-naphthyl) fluorene, 9,9-bis[9-(2-hydroxyethoxy)-3-phenanthyl]-3,6-di(1-naphthyl) fluorene, 9,9-bis(3-hydroxyphenanthyl)-3,6-di(1-naphthyl) fluorene, 9,9-bis[9-(2-hydroxyethoxy)-3-phenanthyl]-4,5-di(1-naphthyl) fluorene, and 9,9-bis(3-hydroxyphenanthyl)-4,5-di(1-naphthyl) fluorene, represented by Formula (a-4) below.

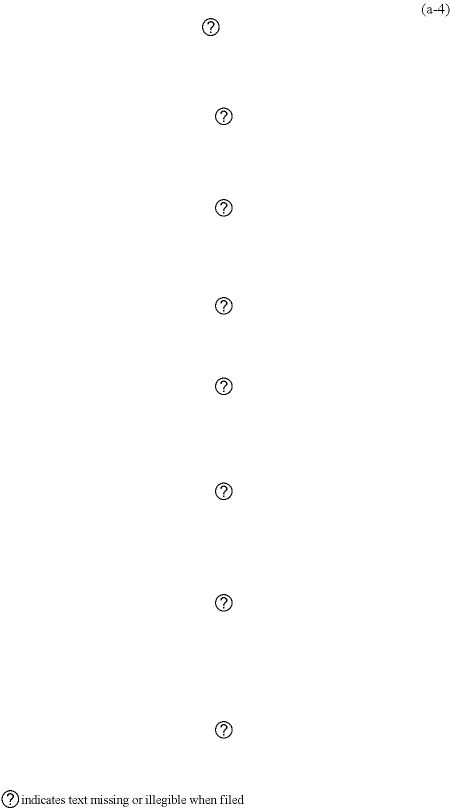

When rings Z are each phenanthrene and R³ and R⁴ are each 2-naphthalene, examples thereof include 9,9-bis[9-(2-hydroxyethoxy)-3-phenanthyl]-1,8-di(2-naphthyl) fluorene, 9,9-bis(3-hydroxyphenanthryl)-1,8-di(2-naphthyl) fluorene, 9,9-bis[9-(2-hydroxyethoxy)-3-phenanthryl]-2,7-di(2-naphthyl) fluorene, 9,9-bis(3-hydroxyphenanthryl)-2,7-di(2-naphthyl) fluorene, 9,9-bis[9-(2-hydroxyethoxy)-3-phenanthryl]-3,6-di(2-naphthyl) fluorene, 9,9-bis(3-hydroxyphenanthryl)-3,6-di(2-naphthyl) fluorene, 9,9-bis[9-(2-hydroxyethoxy)-3-phenanthryl]-4,5-di(2-naphthyl) fluorene, and 9,9-bis(3-hydroxyphenanthryl)-4,5-di(2-naphthyl) fluorene, represented by Formula (a-5) below.

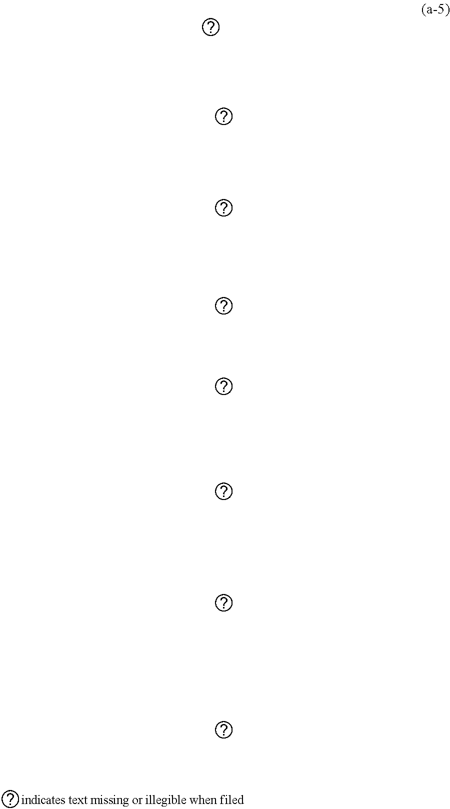

When rings Z are each phenanthrene and R⁵ and R⁴ are each phenanthrene, examples thereof include 9,9-bis[9-(2-hydroxyethoxy)-3-phenanthryl]-1,8-di(9-phenanthryl) fluorene, 9,9-bis(3-hydroxyphenanthryl)-1,8-di(9-phenanthryl) fluorene, 9,9-bis[9-(2-hydroxyethoxy)-3-phenanthryl]-2,7-di(9-phenanthryl) fluorene, 9,9-bis(3-hydroxyphenanthryl)-2,7-di(9-phenanthryl) fluorene, 9,9-bis[9-(2-hydroxyethoxy)-3-phenanthryl]-3,6-di(9-phenanthryl) fluorene, 9,9-bis(3-hydroxyphenanthryl)-3,6-di(9-phenanthryl) fluorene, 9,9-bis[9-(2-hydroxyethoxy)-3-phenanthryl]-4,5-di(9-phenanthryl) fluorene, and 9,9-bis(3-hydroxyphenanthryl)-4,5-di(9-phenanthryl) fluorene, represented by Formula (a-6) below.

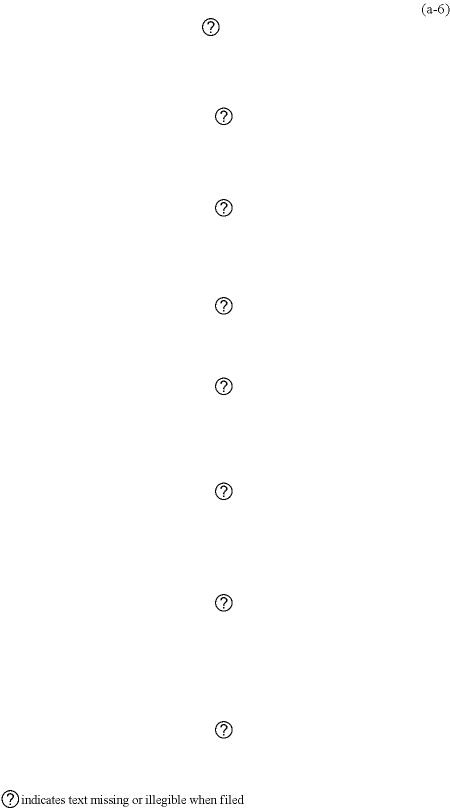

Of the above,
Formula (a′-1) below: 9,9-bis[9-(2-hydroxyethoxy)-3-phenanthryl]fluorene,
Formula (a′-2) below: 9,9-bis[9-(2-hydroxyethoxy)-3-phenanthryl]-2,7-diphenylfluorene,
Formula (a′-3) below: 9,9-bis[9-(2-hydroxyethoxy)-3-phenanthryl]-2,7-di(1-naphthyl) fluorene,
Formula (a′-4) below: 9,9-bis[9-(2-hydroxyethoxy)-3-phenanthryl]-2,7-di(2-naphthyl) fluorene, and
Formula (a′-5) below: 9,9-bis[9-(2-hydroxyethoxy)-3-phenanthryl]-2,7-di(9-phenanthryl) fluorene shown in the Formulas (a′-1) to (a′-5) below are particularly preferable. These may be used individually, or may be used in a combination of two or more.

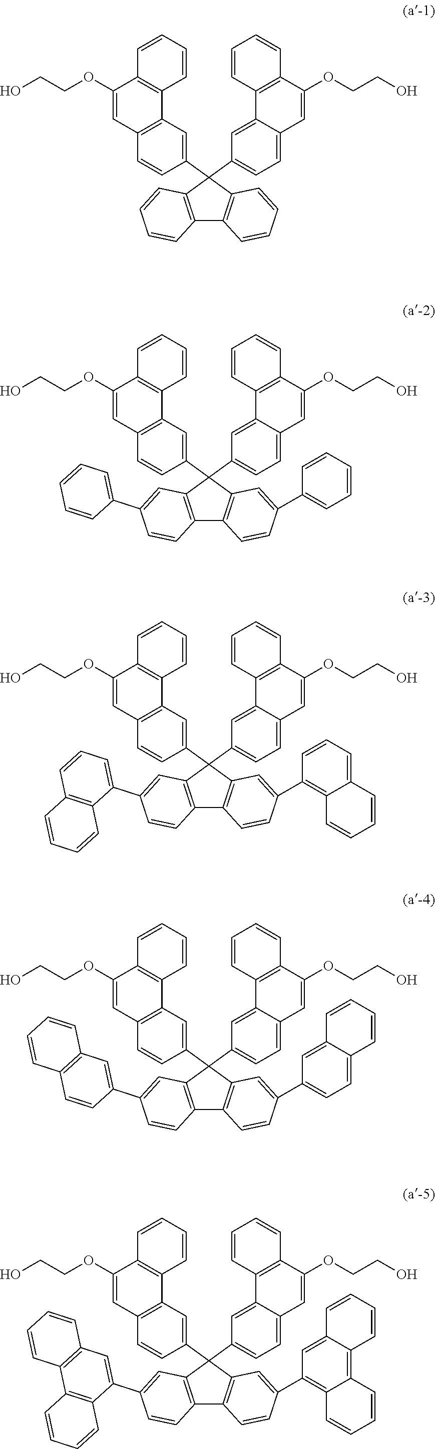

### (Carbonate Component in the Formula (1))

Examples of the carbonate component used in the unit represented by the Formula (1) of the thermoplastic resin of the present invention include phosgene and carbonate esters. Examples of carbonate esters include esters of optionally substituted aryl groups having 6 to 10 carbon atoms, aralkyl groups, or alkyl groups having 1 to 4 carbon atoms. Specific examples include diaryl carbonates such as diphenyl carbonate, ditolyl carbonate, bis(chlorophenyl) carbonate, bis(m-cresyl) carbonate, and dinaphthyl carbonate; dialkyl carbonates such as dimethyl carbonate, diethyl carbonate, dibutyl carbonate, and dicyclohexyl carbonate; alkylaryl carbonates such as ethyl phenyl carbonate and cyclohexyl phenyl carbonate; and dialkenyl carbonates such as divinyl carbonate, diisopropenyl carbonate, and dipropenyl carbonate. Of these, diaryl carbonates are preferable, and diphenyl carbonate is more preferable.

### (Dicarboxylic Acid Component in the Formula (1))

Preferably, the dicarboxylic acid represented by Formula (b) or an ester-forming derivative thereof is used mainly as the dicarboxylic acid component used in the unit represented by the Formula (1) of the thermoplastic resin of the present invention.

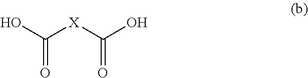

In the Formula (b), X represents a divalent linking group, and the same as explained in the Formula (3) can be said therefor.

Hereinafter, typical specific examples of the dicarboxylic acid represented by the Formula (b) or ester-forming derivatives thereof are shown. However, the raw materials used in the Formula (1) of the present invention are not limited thereto.

Examples of the dicarboxylic acid component used in the thermoplastic resin of the present invention, in addition to 2,2′-bis(carboxymethoxy)-1,1′-binaphthyl, 6,6″-diphenyl-2,2′-bis(carboxymethoxy)-1.1″-binaphthyl, 6,6′-dibromo-2,2′-bis(carboxymethoxy)-1,1′-binaphthyl, and 9,9-bis(2-carboxyethyl) fluorene, which are each a raw material in the Formula (6), include aliphatic dicarboxylic acid components such as malonic acid, succinic acid, glutaric acid, adipic acid, pimelic acid, suberic acid, azelaic acid, methylmalonic acid, and ethylmalonic acid: monocyclic aromatic dicarboxylic acid components such as phthalic acid, isophthalic acid, and terephthalic acid: polycyclic aromatic dicarboxylic acid components such as 2,6-naphthalenedicarboxylic acid, 2,7-naphthalenedicarboxylic acid, 2,3-naphthalenedicarboxylic acid, 1,4-naphthalenedicarboxylic acid, 1,8-naphthalenedicarboxylic acid, anthracene dicarboxylic acid, phenanthrene dicarboxylic acid, 9,9-bis(carboxymethyl) fluorene, 9,9-bis(1-carboxyethyl) fluorene, 9,9-bis(1-carboxypropyl) fluorene, 9,9-bis(2-carboxypropyl) fluorene, 9,9-bis(2-carboxy-1-methylethyl) fluorene, 9,9-bis(2-carboxy-1-methylpropyl) fluorene, 9,9-bis(2-carboxy butyl) fluorene, 9,9-bis(2-carboxy-1-methylbutyl) fluorene, 9,9-bis(5-carboxypentyl) fluorene, and 9,9-bis(carboxycyclohexyl) fluorene: biphenyl dicarboxylic acid components such as 2,2″-biphenyldicarboxylic acid; and alicyclic dicarboxylic acid components such as 1,4-cyclohexanedicarboxylic acid and 2,6-decalindicarboxylic acid. Isophthalic acid, terephthalic acid, 2,6-naphthalenedicarboxylic acid, 2,2′-bis(carboxymethoxy)-1,1′-binaphthyl, 9,9′-bis(2-carboxyethyl) fluorene are preferable, and 2,6-naphthalenedicarboxylic acid, 2,2′-bis(carboxymethoxy)-1,1′-binaphthyl, and 9,9-bis(2-carboxyethyl) fluorene are more preferable. These may be used individually or in a combination of two or more. As the ester-forming derivative, acid chlorides and esters such as methyl esters, ethyl esters, and phenyl esters may be used.

### (Components of the Formulas (7) to (10))

The thermoplastic resin of the present invention may further comprise a repeating unit of any of the Formulas (7) to (10). The dihydroxy compound components, which are each a raw material in the Formulas (7) to (10), are shown below. These may be used individually, or may be used in a combination of two or more.

Examples of the dihydroxy compound component as a raw material in the Formula (7) of the present invention include 2,2′-bis(2-hydroxyethoxy)-1,1′-binaphthyl, 2,2′-bis(2-hydroxyethoxy)-3,3′-diphenyl-1.1″-binaphthyl, 2,2′-bis(2-hydroxyethoxy)-6,6′-diphenyl-1,1′-binaphthyl, 2,2′-bis(2-hydroxyethoxy)-7,7′-diphenyl-1,1′-binaphthyl, 2,2′-bis(2-hydroxyethoxy)-3,3′-dimethyl-1,1′-binaphthyl, 2,2′-bis(2-hydroxyethoxy)-6,6′-dimethyl-1,1′-binaphthyl, and 2,2′-bis(2-hydroxyethoxy)-7,7-dimethyl-1,1′-binaphthyl.

For the dihydroxy compound component as a raw material in the Formula (8) of the present invention, 9,9-bis(4-(2-hydroxyethoxy)phenyl) fluorene, 9,9-bis(4-(2-hydroxyethoxy)-3-methylphenyl) fluorene, 9,9-bis(4-(2-hydroxyethoxy)-3-cyclohexylphenyl) fluorene, and 9,9-bis(4-(2-hydroxyethoxy)-3-phenylphenyl) fluorene are exemplified. 9,9-bis(4-(2-hydroxyethoxy)phenyl) fluorene and 9,9-bis(4-(2-hydroxyethoxy)-3-phenylphenyl) fluorene are particularly preferable. These may be used individually, or may be used in a combination of two or more.

Examples of the dihydroxy compound component as a raw material in the Formula (9) of the present invention include 9,9-bis(6-(2-hydroxyethoxy)-2-naphthyl) fluorene and 9,9-bis(6-(2-hydroxyethoxy)-2-naphthyl)-2,7-diphenylfluorene.

For the dihydroxy compound component as a raw material in the Formula (10) of the present invention. 2,2-bis(4-hydroxyphenyl) propane, 2,2-bis(3-methyl-4-hydroxyphenyl) propane, 1,1-bis(4-hydroxyphenyl)-1-phenylethane, 1,3-bis(2-(4-hydroxyphenyl)-2-propyl)benzene, 1,1-bis(4-hydroxyphenyl)-3,3,5-trimethylcyclohexane, 1,1-bis(4-hydroxyphenyl)cyclohexane, bis(4-hydroxyphenyl)diphenylmethane. 1,1-bis(4-hydroxyphenyl) decane, bis(4-hydroxyphenyl) sulfide, bis(4-hydroxy-3-methylphenyl) sulfide, biphenol, 9,9-bis(4-hydroxyphenyl) fluorene, 9,9-bis(4-hydroxy-3-methylphenyl) fluorene, 9,9-bis(4-hydroxy-3-cyclohexylphenyl) fluorene, 9,9-bis(4-hydroxy-3-phenylphenyl) fluorene, bis(4-hydroxyphenyl) sulfone, and 10,10-bis(4-hydroxyphenyl) anthrone are exemplified. 2,2-bis(4-hydroxyphenyl) propane and bis(4-hydroxyphenyl) sulfide are particularly preferable. These may be used individually, or may be used in a combination of two or more.

Among Formulas (7) to (10), 2,2′-bis(2-hydroxyethoxy)-1,1′-binaphthyl, 9,9-bis(4-(2-hydroxyethoxy)phenyl) fluorene, 9,9-bis(4-(2-hydroxyethoxy)-3-phenylphenyl) fluorene, 9,9-bis(6-(2-hydroxy ethoxy)-2-naphthyl) fluorene, and 9,9-bis(6-(2-hydroxyethoxy)-2-naphthyl)-2,7-diphenylfluorene are particularly preferable, since a balance of high refractive index, high heat resistance, and low birefringence can be obtained.

The thermoplastic resin of the present invention is manufactured, for example, by a method of reacting a dihydroxy compound component with a carbonate precursor such as phosgene or a carbonic acid diester or a method of reacting a diol component with a dicarboxylic acid or an ester-forming derivative thereof. Specific examples of the method are shown below.

### <Manufacturing Method>

### (Manufacturing Method of Polycarbonate Resin)

The thermoplastic resin of the present invention, in the case of a polycarbonate resin, is obtained by a reaction means known per se, for example, reacting a dihydroxy compound component with a carbonate precursor via an interfacial polymerization method or a melt polymerization method. When manufacturing the polycarbonate resin, a catalyst, a chain terminator, or an antioxidant may be used as needed.

### (Manufacturing Method of Polyester Resin)

The thermoplastic resin of the present invention, in the case of a polyester resin, needs only to be a high-molecular-weight body having a desired molecular weight, obtained by a reaction means known per se, for example, subjecting a dihydroxy compound component to an esterification reaction or a transesterification reaction with a dicarboxylic acid or an ester-forming derivative thereof, and then subjecting the obtained reaction product to a polycondensation reaction.

### (Manufacturing Method of Polyester Carbonate Resin)

The thermoplastic resin of the present invention, in the case of a polyester carbonate resin, can be manufactured by reacting a dihydroxy compound component, a dicarboxylic acid or an ester-forming derivative thereof, and a carbonate precursor such as phosgene or a carbonate ester.

The same polymerization method as the method for the polycarbonate resin or the polyester resin can be used.

### <Optical Member>

The optical member of the present invention comprises the above thermoplastic resin. For optical applications where the above thermoplastic resin is useful, examples of such an optical member can include, but are not limited to, optical lenses, optical disks, transparent conductive boards, optical cards, sheets, films, optical fibers, lenses, prisms, optical membranes, bases, optical filters, and hard coatings.

The optical member of the present invention may be composed of a resin composition comprising the above thermoplastic resin. The resin composition can be blended with an additive such as a heat stabilizer, a plasticizer, a photostabilizer, a polymeric metal deactivator, a flame retardant, a lubricant, an antistatic agent, a surfactant, an antibacterial agent, an ultraviolet absorber, a mold release agent, and an antioxidant, as needed.

Examples of the antioxidant include triethylene glycol-bis[3-(3-tert-butyl-5-methyl-4-hydroxyphenyl)proprionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamate), 3,5-di-tert-butyl-4-hydroxy-benzylphosphonate-diethyl ester, tris(3,5-di-tert-butyl-4-hydroxybenzyl)isocyanurate, and 3,9-bis{1,1-dimethyl-2-[β-(3-tert-butyl-4-hydroxy-5-methylphenyl)proprionyloxy]ethyl}-2,4,8,10-tetraoxaspiro(5,5) undecane. The blending amount of the antioxidant, relative to 100 parts by mass of the thermoplastic resin composition, is preferably 0.50 parts by mass or less, more preferably 0.05 to 0.40 parts by mass, even more preferably 0.05 to 0.20 parts by mass or 0.10 to 0.40 parts by mass, and particularly preferably 0.20 to 0.40 parts by mass.

### <Optical Lens>

Examples of the optical member of the present invention can include, in particular, optical lenses. Examples of such optical lenses can include optical lenses for mobile phones, smartphones, tablet terminals, personal computers, digital cameras, video cameras, in-vehicle cameras, and surveillance cameras.

The optical lens of the present invention can be molded and processed by any method such as injection molding, compression molding, injection compression molding, melt extrusion molding, or casting. However, injection molding is particularly suitable.

The molding conditions of injection molding are not particularly limited, but the cylinder temperature of the molding machine is preferably 180 to 320° C., more preferably 220 to 300° C., and particularly preferably 240 to 290° C. The mold temperature is preferably 70 to 130° C. more preferably 80 to 125° C., and particularly preferably 90 to 120° C. The injection pressure is preferably 5 to 170 MPa, more preferably 50 to 160 MPa, and particularly preferably 100 to 150 MPa.

The present invention will be further specifically described by way of the following Examples. However, the present invention is not limited thereto.

### EXAMPLES

### [Reference Example 1] Synthesis of 9,9-bis[9-(2-hydroxyethoxy)-3-phenanthryl]fluorene

In a nitrogen atmosphere, 5.00 g of fluorenone, 10.78 of 9-phenanthrol, 0.20 g of 1-octanethiol, 0.09 g of phosphotungstic acid, 20 ml of toluene. 5 ml of γ-butyrolactone were added to a flask equipped with a stirrer, a condenser, and a thermometer and reacted at 100° C., and 50 k Pa for 10 h. After the reaction liquid was cooled, 100 ml of toluene was added, the reaction liquid was transferred to a separating funnel, and a NaOH aqueous solution was added to carry out neutralization washing. The product was then washed to neutral with distilled water. The organic layer after washing was subjected to HPLC measurement and confirmed to have 78% of 9,9-bis(3-hydroxyphenanthryl) fluorene, 6% of 9-phenanthrol. 9% of fluorenone, and 7% of other unknown components.

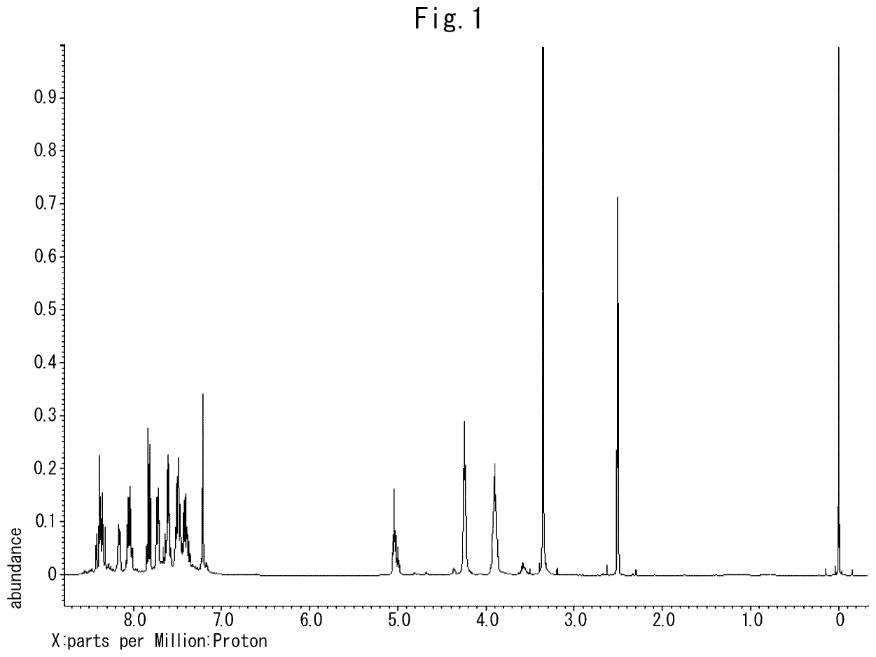

The organic layer, ethylene carbonate: 4.62 g, and potassium carbonate: 0.35 g were charged into a flask equipped with a stirrer, a condenser, and a thermometer in a nitrogen atmosphere, and the reaction liquid was bubbled with nitrogen for 10 min and then reacted at 110° C. for 18 h. After the reaction liquid was cooled, 300 ml of toluene was added, the reaction liquid was transferred to a separating funnel, and after washing with a NaOH aqueous solution, the product was washed to neutral with distilled water. Hexane was then added to the organic layer for recrystallization. The obtained crystals were collected, dissolved in toluene, recrystallized by adding hexane, and dried under reduced pressure for 4 h. whereby crystals of 9,9-bis[9-(2-hydroxyethoxy)-3-phenanthryl]fluorene (hereinafter, may be abbreviated as BPhEF) were obtained (purity: 96%, yield: 4.8 g). In addition, a H NMR chart of the obtained BPhEF is shown in FIG. 1.

### Example 1

12.78 parts by mass (20 mol %) of BPhEF, 35.08 parts by mass (80 mol %) of 9,9′-bis[4-(2-hydroxy ethoxy)phenyl]fluorene (hereinafter, may be abbreviated as BPEF), 21.53 parts by mass (100.5 mol %) of diphenyl carbonate (hereinafter, may be abbreviated as DPC), and as a catalyst, 8.40×10⁻⁴ parts by mass (1.00×10⁻⁴ mol %) of sodium hydrogen carbonate at a concentration of 100 mmol/L were added, heated, and melted at 180° C. in a nitrogen atmosphere. The degree of pressure reduction was then adjusted to 20 kPa over a period of 5 min. The temperature was increased to 250° C. at a temperature increase rate of 60° C./hr. After the outflowing amount of phenol reached 70%, the pressure was reduced at 60 kPa/hr, the polymerization reaction was carried out until the predetermined power was reached, and the reaction was completed. The resin was then removed from the flask.

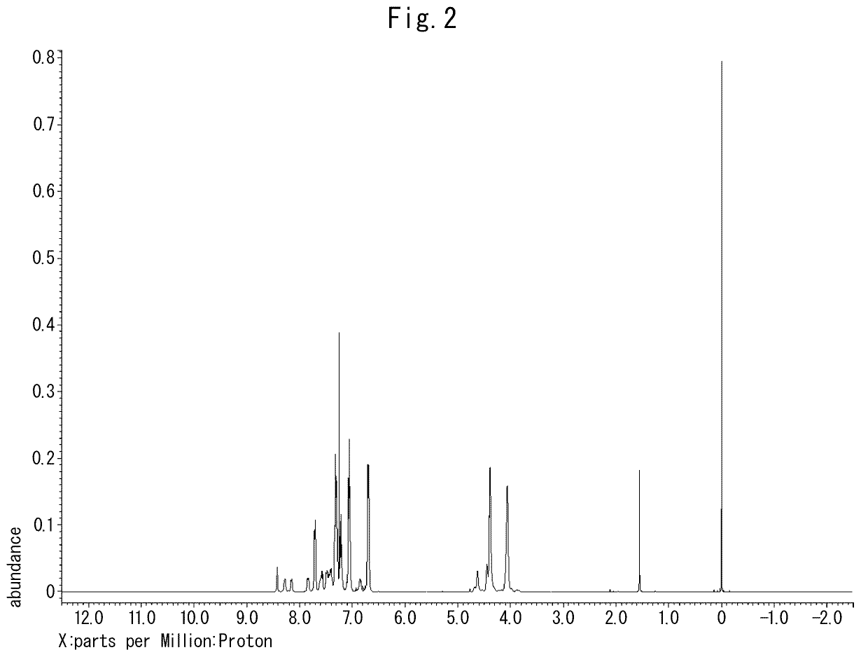

The obtained polycarbonate resin was analyzed by H NMR and confirmed to have a BPhEF component of 20 mol % relative to all monomers and a BPEF component of 80 mol % relative to all monomers introduced therein. Using the polycarbonate resin, the copolymerization ratio, refractive index, Abbe number, Tg, and Δn were evaluated. The results are shown in Table 1. In addition, a H NMR chart of the obtained polycarbonate resin is shown in FIG. 2.

### Example 2

Except that BPhEF was changed to 19.16 parts by mass (30 mol %) and BPEF to 30.7 parts by mass (70 mol %), a polycarbonate resin was manufactured in the same manner as in Example 1. Using the polycarbonate resin, the copolymerization ratio, refractive index, Abbe number. Tg, and Δn were evaluated. The results are shown in Table 1.

### Example 3

Except that BPhEF was changed to 63.88 parts by mass (100 mol %), a polycarbonate resin was manufactured in the same manner as in Example 1. Using the polycarbonate resin, the copolymerization ratio, refractive index, Abbe number, Tg, and Δn were evaluated. The results are shown in Table 1.

### Example 4

Except that 15.97 parts by mass (25 mol %) of BPhEF, 11.23 parts by mass (30 mol %) of 2,2-bis(2-hydroxyethoxy)-1,1′-binaphthyl (hereinafter, may be abbreviated as BHEB), 18.11 parts by mass (45 mol %) of 2,2′-bis(carboxymethoxy)-1,1′-binaphthyl (hereinafter, may be abbreviated as BCMB), 2.19 parts by mass (10.2 mol %) of DPC, and as a catalyst, 3.4×10⁻² parts by mass (1.0×10⁻³ mol %) of titanium tetrabutoxide were used, a polyester carbonate resin was manufactured in the same manner as in Example 1. Using the polyester carbonate resin, the copolymerization ratio, refractive index, Abbe number, Tg, and Δn were evaluated. The results are shown in Table 1.

### Example 5

Except that BPhEF was changed to 36.4 parts by mass (25 mol %) and BHEB to 63.6 parts by mass (75 mol %), a polycarbonate resin was manufactured in the same manner as in Example 1. Using the polycarbonate resin, the copolymerization ratio, refractive index, Abbe number, Tg, and Δn were evaluated. The results are shown in Table 1.

### Comparative Example 1

Except that 43.85 parts by mass (100 mol %) of BPEF was used in place of BPhEF, a polycarbonate resin was manufactured in the same manner as in Example 1. Using the polycarbonate resin, the copolymerization ratio, refractive index, Abbe number, Tg, and Δn were evaluated. The results are shown in Table 1.

### Comparative Example 2

Except that 53.86 parts by mass (100 mol %) of 9,9-bis[6-(2-hydroxyethoxy)-2-naphthyl]fluorene (hereinafter, may be abbreviated as BNEF) was used in place of BPhEF, a polycarbonate resin was manufactured in the same manner as in Example 1. Using the polycarbonate resin, the copolymerization ratio, refractive index, Abbe number, Tg, and Δn were evaluated. The results are shown in Table 1.

### Comparative Example 3

Except that 55.27 parts by mass (20 mol %) of 9,9-bis(6-(2-hydroxyethoxy)-2-naphthyl)-2,7-diphenylfluorene (hereinafter, may be abbreviated as BNDP2) and 35.08 parts by mass (80 mol %) of BPEF were used in place of BPhEF, a polycarbonate resin was manufactured in the same manner as in Example 1. Using the polycarbonate resin, the copolymerization ratio, refractive index, Abbe number, Tg, and Δn were evaluated. The results are shown in Table 1.

The obtained thermoplastic resin was evaluated by the following methods.

### Comparative Example 4

Except that 69.08 parts by mass (100 mol %) of 9,9-bis(6-(2-hydroxyethoxy)-2-naphthyl)-2,7-diphenylfluorene (hereinafter, may be abbreviated as BNDP2) was used in place of BPhEF, a polycarbonate resin was manufactured in the same manner as in Example 1. Using the polycarbonate resin, the copolymerization ratio, refractive index, Abbe number, Tg, and Δn were evaluated. The results are shown in Table 1.

The obtained thermoplastic resin was evaluated by the following methods.

### <Copolymerization Ratio>

The compositional ratio of each polymer was calculated by subjecting the obtained resin to ¹H NMR measurement using a JNM-ECZ400S manufactured by JEOL Ltd. CDCl₃ was used as the solvent.

### <Optical Characteristics>

### (Refractive Index)

A 3 mm thick test piece of each polymer was prepared and polished, and then measured for refractive index nd (587.56 nm) at 20° C.′ using a Kalnew Precision Refractometer KPR-2000 manufactured by Shimadzu Corporation.

### (Abbe Number)

The Abbe number was calculated from the refractive indices at 486.13 nm, 587.56 nm, and 656.27 nm using the following formula.

$$vd = ( nd - 1 ) / ( nF - nC )$$

$$nd : refractive index at wavelength of 587.56 nm ,$$

$$nF : refractive index at wavelength of 486.13 nm , and$$

$$nC : refractive index at wavelength of 656.27 nm .$$

### (Absolute Value of Orientation Birefringence)

The thermoplastic resin was dissolved in methylene chloride, then cast onto a glass petri dish, and sufficiently dried to produce a cast film having a thickness of 100 μm. The film was stretched two-fold at Tg+10° C., the retardation (Re) at 589 nm was measured using an ellipsometer M-220 manufactured by JASCO Corporation, and an absolute value of the orientation birefringence (|Δn|) was determined by the following formula.

$$\vert Δ n \vert = \vert Re / d \vert$$

$$Δ n : orientation birefringence$$

$$Re : retardation ( nm )$$

$$d : thickness ( nm )$$

### <Glass Transition Temperature (Tg)>

The obtained resin was measured with a Discovery DSC 25 Auto model manufactured by TA Instruments Japan Inc. at a temperature increase rate of 20° C./min. Samples were measured at 5 to 10 mg.

### <<Results>>

The evaluation results of specific examples of the thermoplastic resin are shown in Table 1. In addition, a ¹H NMR spectrum of BPhEF of Reference Example 1 is shown in FIG. 1, and a ¹H NMR spectrum of the thermoplastic resm of Example 1 is shown in FIG. 2.

TABLE 1

| | Copolymerization ratio (mol %) | | | | | | Evaluation results | | | |
|---|---|---|---|---|---|---|---|---|---|---|
| | Diol | | | | | Dicarboxylic acid | Refractive index | Abbe number | Tg | \|Δn\| |
| | BPhEF | BPEF | BHEB | BNEF | BNDP2 | BCMB | nd | νd | ° C. | ×10⁻³ |
| Example 1 | 20 | 80 | | | | | 1.66 | 21 | 165 | 0.5 |
| Example 2 | 30 | 70 | | | | | 1.66 | 20 | 173 | 1.6 |
| Example 3 | 100 | | | | | | 1.71 | 16 | 214 | 4.4 |
| Example 4 | 25 | | 30 | | | 45 | 1.69 | 17 | 159 | 1.5 |
| Example 5 | 25 | | 75 | | | | 1.68 | 18 | 151 | 1.7 |
| Comparative Example 1 | | 100 | | | | | 1.64 | 24 | 147 | 0.8 |
| Comparative Example 2 | | | | 100 | | | 1.68 | 19 | 178 | 7.3 |
| Comparative Example 3 | | 80 | | | 20 | | 1.66 | 20 | 162 | 3.0 |
| Comparative Example 4 | | | | | 100 | | 1.71 | 14 | 196 | 8.5 |

It was found that Examples 1 to 5, which used BPhEF, had high refractive indices, could achieve a balance of heat resistance and refractive index, and were excellent as optical lenses.

Although the copolymerization partner and the copolymerization ratio were identical for Example 1 and Comparative Example 3, or Example 3 and Comparative Example 4, the difference in birefringence therebetween was large. It was found that the phenanthryl group, which is classified as a phenacene group having a bent structure, increased the refractive index while suppressing an increase in birefringence in the main chain direction, and was excellent for optical material applications. Further, introducing an aromatic group into the fluorene skeleton is effective in terms of increasing the refractive index or decreasing birefringence.

### INDUSTRIAL APPLICABILITY

The thermoplastic resin of the present invention is suitable for use in optical members, can be used specifically in optical members such as optical lenses, optical disks, transparent conductive boards, optical cards, sheets, films, optical fibers, lenses, prisms, optical membranes, bases, optical filters, and hard coatings, and is very useful in optical lenses in particular.

1-16. (canceled)

17. A thermoplastic resin comprising a repeating unit represented by Formula (1) below: 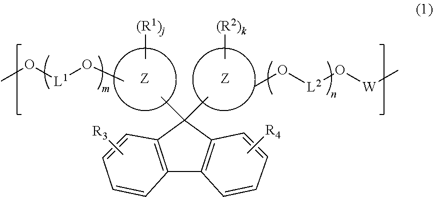
where rings Z (identical or different) each represent a polycyclic aromatic hydrocarbon of 3 or more bonded benzene rings; R¹, R², R³, and R⁴ are each independently a hydrogen atom or a halogen atom or represent a substituent having 1 to 20 carbon atoms that may comprise an aromatic group; L¹ and L² each independently represent a divalent linking group; j and k each independently represent an integer of 1 or greater; m and n each independently represent 0 or 1; and W is at least one selected from the group represented by Formula (2) or (3) below: 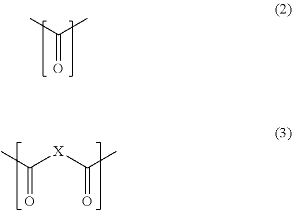
where X represents a divalent linking group.

18. The thermoplastic resin according to claim 17, wherein the repeating unit represented by the Formula (1) is at least one selected from the group represented by Formulas (1a) to (1d) below: 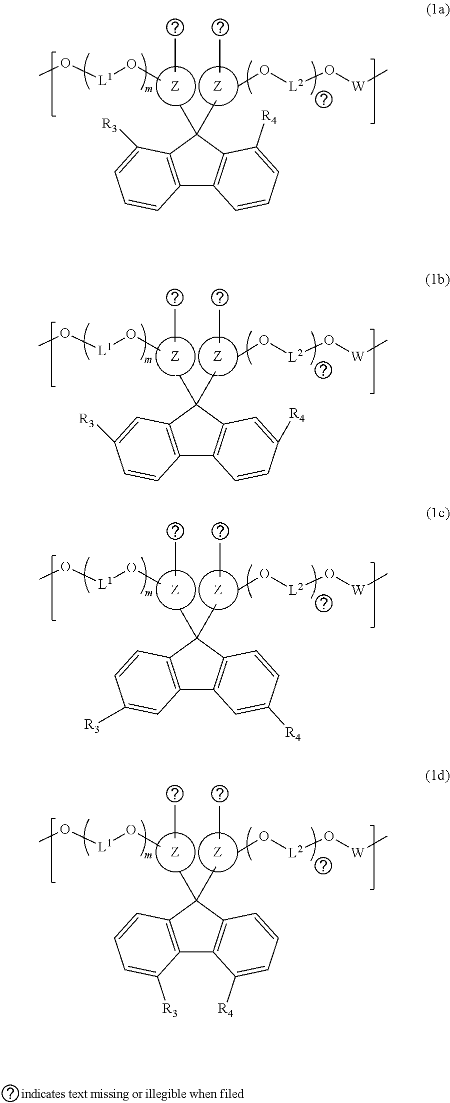
where rings Z (identical or different) are each a polycyclic aromatic hydrocarbon of 3 or more bonded benzene rings; R¹, R², R³, and R⁴ are each independently a hydrogen atom or a halogen atom or represent a substituent having 1 to 20 carbon atoms that may comprise an aromatic group; L¹ and L² each independently represent a divalent linking group; j and k each independently represent an integer of 1 or greater; m and n each independently represent 0 or 1; and W is at least one selected from the group represented by the Formula (2) or (3).

19. The thermoplastic resin according to claim 18, wherein the Formula (1) is the Formula (1b).

20. The thermoplastic resin according to claim 17, wherein ring Z in the Formula (1) is a phenacene-type polycyclic aromatic hydrocarbon.

21. The thermoplastic resin according to claim 17, wherein ring Z in the Formula (1) is phenanthrene.

22. The thermoplastic resin according to claim 17, wherein the repeating unit represented by the Formula (1) is represented by Formula (4) below: 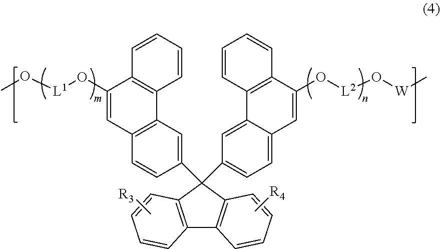
where R³ and R⁴ are each independently a hydrogen atom or a halogen atom or represent a substituent having 1 to 20 carbon atoms that may comprise an aromatic group; L¹ and L² each independently represent a divalent linking group; m and n each independently represent 0 or 1; and W is at least one selected from the group represented by the Formula (2) or (3).

23. The thermoplastic resin according to claim 17, where in the Formula (1), R³ and R⁴ each represent a hydrogen atom, a methyl group, a phenyl group, a naphthyl group, or a phenanthryl group.

24. The thermoplastic resin according to claim 17, wherein R³ and R⁴ in the Formula (1) are each a hydrogen atom.

25. The thermoplastic resin according to claim 17, wherein X in the Formula (3) comprises, as a repeating unit, at least one selected from the group consisting of a phenylene group, a naphthalenediyl group, a group represented by Formula (5) below, and a group represented by Formula (6) below: 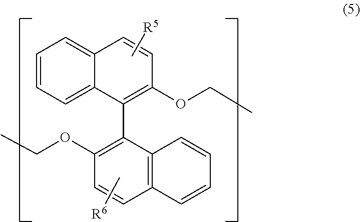
where R⁵ and R⁶ are each independently a hydrogen atom or a halogen atom, or a hydrocarbon group having 1 to 20 carbon atoms that may comprise an aromatic group, and

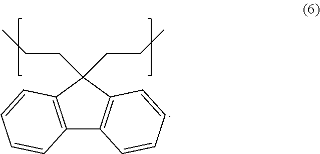

26. The thermoplastic resin according to claim 17, comprising, as a repeating unit, at least one selected from the group consisting of units represented by Formulas (7) to (10) below: 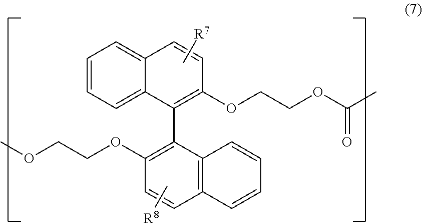
where R⁷ and R⁸ are each independently a hydrogen atom or a halogen atom, or a hydrocarbon group having 1 to 20 carbon atoms that may comprise an aromatic group, 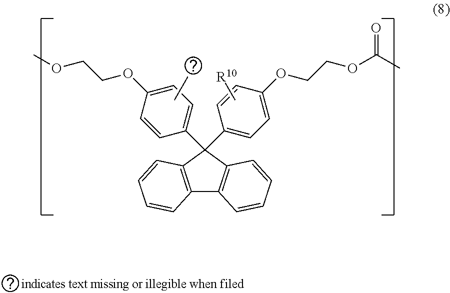
where R⁹ and R¹⁰ are each independently a hydrogen atom or a halogen atom, or a substituent having 1 to 20 carbon atoms that may comprise an aromatic group, 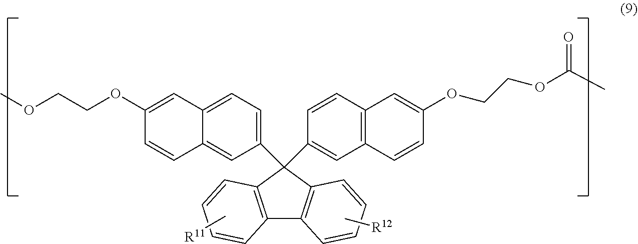
where R¹¹ and R¹² are each independently a hydrogen atom or a halogen atom, or a substituent having 1 to 20 carbon atoms that may comprise an aromatic group, and 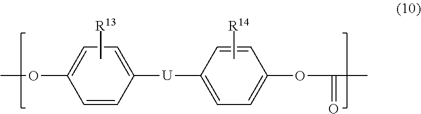
where R¹³ and R¹⁴ are each independently a hydrogen atom or a halogen atom, or a substituent having 1 to 20 carbon atoms that may comprise an aromatic group; and U is a single bond or a divalent linking group.

27. The thermoplastic resin according to claim 17, which has a specific viscosity of 0.12 to 0.40.

28. The thermoplastic resin according to claim 17, which has a refractive index of 1.65 to 1.80.

29. The thermoplastic resin according to claim 17, which has a glass transition temperature of 130 to 190° C.

30. The thermoplastic resin according to claim 17, which has an absolute value of orientation birefringence of 6.0×10³ or less.

31. An optical member comprising the thermoplastic resin according to claim 17.

32. The optical member according to claim 31, which is an optical lens.
